(19) United States
(12) Patent Application Publication
(10) Pub. No.: US 2022/0402085 A1
(43) Pub. Date: Dec. 22, 2022

(54) MACHINING METHOD

(71) Applicant: National University Corporation Tokai National Higher Education and Research System, Nagoya-shi (JP)

(72) Inventors: Eiji SHAMOTO, Nagoya-shi Aichi (JP); Takehiro HAYASAKA, Nagoya-shi Aichi (JP); Keigo MIYAGAWA, Nagoya-shi Aichi (JP)

(21) Appl. No.: 17/896,521

(22) Filed: Aug. 26, 2022

Related U.S. Application Data
(63) Continuation of application No. PCT/JP2020/008388, filed on Feb. 28, 2020.

(51) Int. Cl. B23Q 15/02

(52) U.S. Cl. CPC B23Q 15/02; B23Q 15/18

(57) ABSTRACT

A spindle motor rotates a spindle to which a cutting tool is attached. A feed mechanism moves the cutting tool relative to a thin workpiece. A machining apparatus repeatedly performs a first process of causing the feed mechanism to feed the cutting tool relative to the thin workpiece in a height direction of a rising wall to perform a plunge process on the thin workpiece, and a second process of causing the feed mechanism to feed the cutting tool relative to the thin workpiece in a width direction or the height direction of the rising wall to perform a finishing process on the thin workpiece.

### CROSS REFERENCE TO RELATED APPLICATIONS

This application is based upon and claims the benefit of priority from International Application No. PCT/JP2020/008388, filed on Feb. 28, 2020, the entire contents of which are incorporated herein by reference.

### BACKGROUND

### 1. Field of the Disclosure

The present disclosure relates to a technique for forming a thin rising wall by means of a cutting process.

### 2. Description of the Related Art

In recent years, the development of the aviation industry has increased the demand for metal processing of aircraft components. Most of the structural components constituting the body of an aircraft are cut out from a block-shaped aluminum alloy material, titanium alloy material, or the like with a cutting tool. In order to make the structural components light in weight, high-accuracy machining is required by which an excess portion of each component is cut off.

FIG. 1 is a diagram showing an example of a structure of a wing rib that is an aircraft component. The wing rib has a rib structure that achieves both high strength and light weight, but when a thin rib is formed, low rigidity in a thickness direction easily causes static bending or vibrations. In particular, when regenerative chatter vibrations occur, a periodic pattern called a chatter mark is generated on a machined surface, which deteriorates a condition of a finished surface and leads to wear on or damage to a tool.

FIG. 2 is a schematic diagram of a milling process that causes regenerative chatter vibrations. Here, it is assumed that the milling process of machining a workpiece to form a thin rib is performed. Generally speaking, in such a milling process, dynamic rigidity other than dynamic rigidity in a plate thickness direction (y direction in FIG. 2) is sufficiently high, and dynamic rigidity of an end mill is sufficiently higher than the dynamic rigidity of the rib, so that it can be thought that compliances other than a compliance of the thin rib in the plate thickness direction are relatively sufficiently small.

A characteristic equation of regenerative chatter vibrations during milling of the thin rib is expressed by the following expression.

[Math. 1]

1−½aₗᵢₘKₜ(1−μᵣe^{-iω}^{_{c}}^{T})α_{0yy}G_{yy}(iω_{c})=0 (1)

where aₗᵢₘ is a stability limit of an axial depth of cut (also referred to as a stability limit of a cutting width), Kₜ is a specific cutting force in an end mill tangential direction, μᵣ is an overlap ratio (a temporal average value of ratios of a cutting width in which the past vibrations are present to a cutting width in which the current vibrations are present, and in the case of milling shown in FIG. 2, μᵣ is approximately 1), i is an imaginary unit, ω_{c} is an angular frequency of chatter vibrations, T is a cutting edge passage period, α_{0yy} is a (average) cutting force coefficient in the y direction due to vibration displacement in the y direction (plate thickness direction), and G_{yy} is a dynamic compliance of the rib in the y direction. From Expression (1), it can be seen that the smaller Kₜ, μᵣ, |α_{0yy}|, and G_{yy} are, the larger the stability limit aₗᵢₘ can be.

α_{0yy} is expressed by the following expression.

$$\begin{matrix}[ Math . 2 ] & \\ {α}_{0 yy} = {\frac{N}{4 π} [ - cos 2 θ - 2 {k}_{r} θ - {k}_{r} sin 2 θ ]}_{{θ}_{st}}^{{θ}_{ex}} & ( 2 )\end{matrix}$$

where N is the number of cutting edges of the end mill, θ is a momentary cutting angle, kᵣ is a force component ratio of the cutting force, and when Kᵣ is a specific cutting force in the radial direction of the end mill, kᵣ is expressed by Kᵣ/Kₜ. θₛₜ and θₑₓ represent a cut start angle and a cut end angle, respectively.

When a rake angle of the end mill in the radial direction is assumed to be 0 [deg] (generally small), the specific cutting force Kᵣ is a component force acting in the radial direction of the end mill of a dynamic frictional force acting on the rake face of the cutting edge. Therefore, the smaller the component force, the smaller the specific cutting force Kᵣ and the force component ratio kᵣ. Further, from Expression (1), on the basis of the fact that the smaller Kₜ, μᵣ, |α_{0yy}|, and G_{yy} are, the larger the stability limit aₗᵢₘ can be, the smaller the force component ratio kᵣ, the more stable machining can be performed.

### SUMMARY

It is therefore an object of the present disclosure to provide a machining technique for stably forming a thin rising wall such as a rib with regenerative chatter vibrations suppressed.

In order to solve the above-described problems, according to one aspect of the present disclosure, there is provided a machining method for forming a rising wall by machining a workpiece, the machining method including a first process of feeding a cutting tool relative to the workpiece in a height direction of the rising wall to perform a plunge process on the workpiece, and a second process of feeding the cutting tool relative to the workpiece in a width direction or the height direction of the rising wall to perform a finishing process on the workpiece, the first process and the second process being repeatedly performed to form the rising wall. A ratio of a height to a wall thickness (height/wall thickness) of the “rising wall” formed by the present machining method may be greater than or equal to 5, or may be greater than or equal to 10.

According to another aspect of the present disclosure, there is provided a machining apparatus that forms a rising wall by machining a workpiece, the machining apparatus including a motor structured to rotate a spindle to which a cutting tool is attached, and a feed mechanism structured to move the cutting tool relative to the workpiece. The machining apparatus repeatedly performs a first process of causing the feed mechanism to feed the cutting tool relative to the workpiece in a height direction of the rising wall to perform a plunge process on the workpiece, and a second process of causing the feed mechanism to feed the cutting tool relative to the workpiece in a width direction or the height direction of the rising wall to perform a finishing process on the workpiece.

### BRIEF DESCRIPTION OF THE DRAWINGS

FIG. 1 is a diagram showing an example of a structure of a wing rib that is an aircraft component;

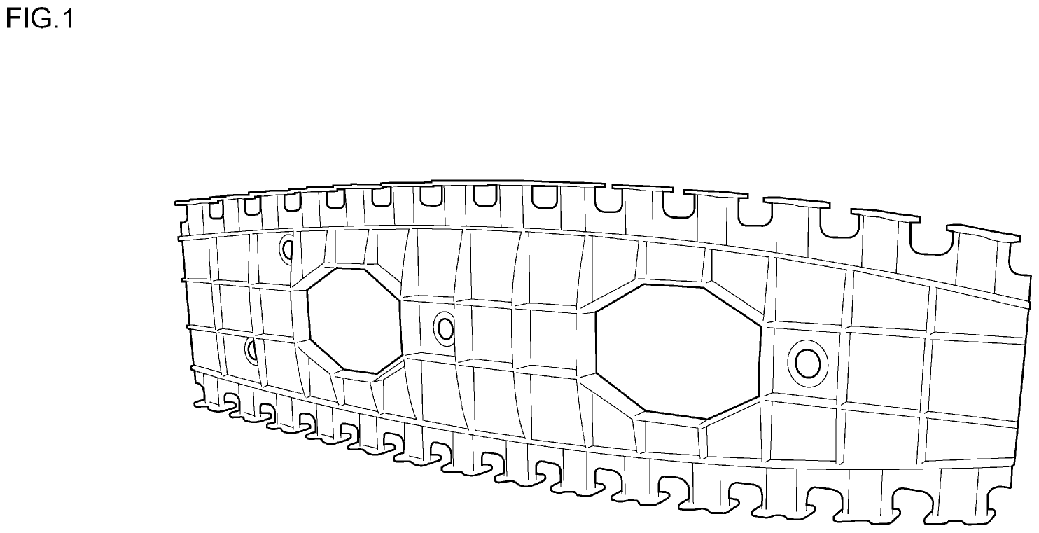

FIG. 2 is a schematic diagram of a milling process that causes regenerative chatter vibrations;

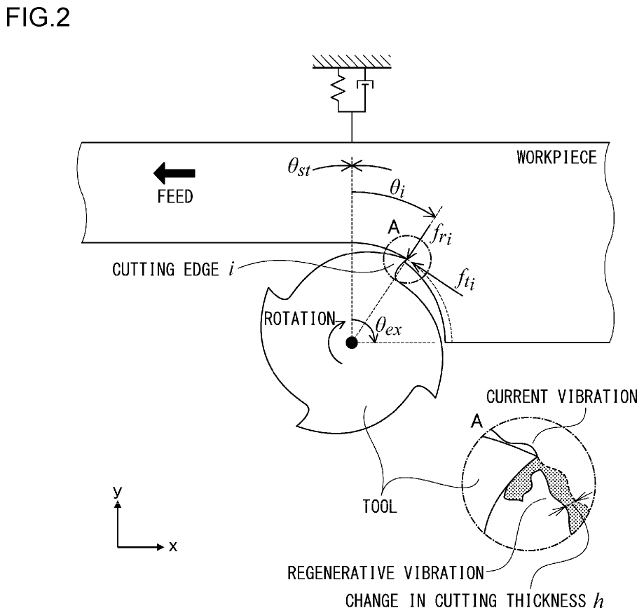

FIG. 3 is a diagram showing a machining apparatus according to an embodiment;

FIGS. 4A, 4B, 4C, and 4D are diagrams for describing an outline of a machining method as a comparative technique;

FIGS. 5A and 5B are diagrams showing a formed rising wall;

FIG. 6 is a diagram schematically showing a state of a thin workpiece that is cut in a finishing process according to the comparative technique;

FIG. 7 is a diagram showing the thin workpiece subjected to a roughing process according to the embodiment;

FIG. 8 is a diagram showing how a plunge process is performed with a cutting tool;

FIG. 9 is a diagram schematically showing a state of the thin workpiece that is cut in the roughing process according to the embodiment;

FIG. 10 is a diagram showing a cusp generated between two machining paths of the roughing process;

FIG. 11 is a diagram schematically showing a state of the thin workpiece that is cut in the finishing process according to the embodiment;

FIG. 12 is a diagram showing an example of a machining path that is a combination of curves;

FIGS. 13A and 13B are diagrams for describing the roughing process on a thin rising wall having a curved cross section; and

FIG. 14 is a diagram for describing the finishing process on the thin rising wall having a curved cross section.

### DETAILED DESCRIPTION

The disclosure will now be described by reference to the preferred embodiments. This does not intend to limit the scope of the present disclosure, but to exemplify the disclosure.

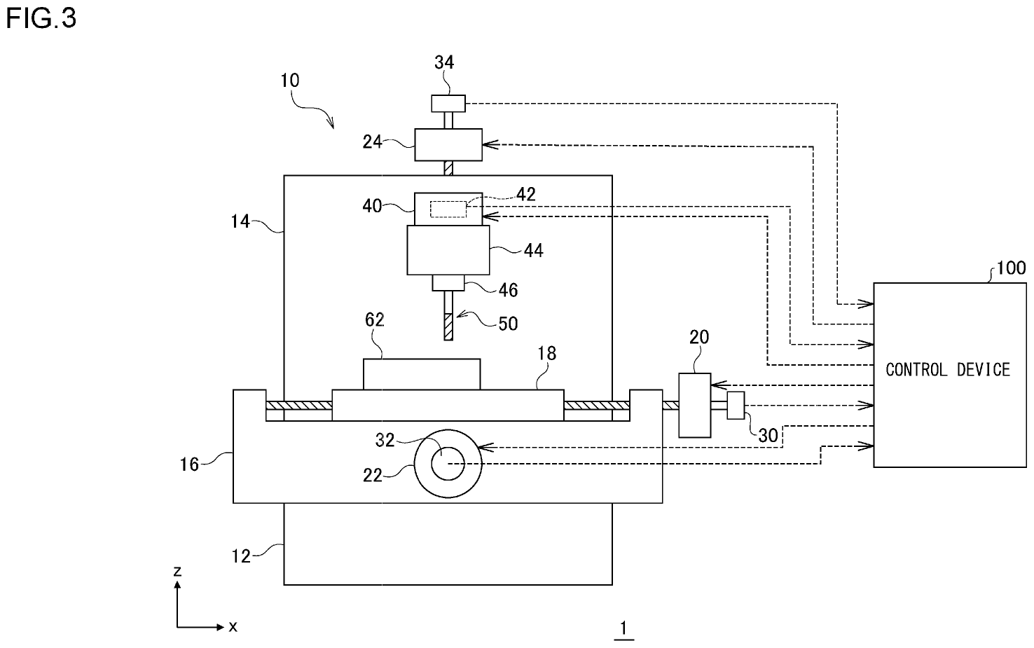

FIG. 3 shows a machining apparatus 1 according to an embodiment. The machining apparatus 1 includes a machine tool 10 and a control device 100. The control device 100 may be a numerical control (NC) control device that controls the machine tool 10 in accordance with an NC program, and the machine tool 10 may be an NC machine tool controlled by the NC control device. In the machining apparatus 1, the machine tool 10 and the control device 100 are separate from each other and connected by a cable or the like, or alternatively may be inseparable from each other.

The machine tool 10 includes a bed 12 and a column 14 that make up a body. On the bed 12, a first table 16 and a second table 18 are supported in a movable manner. The first table 16 is supported by a rail provided on the bed 12 so as to be movable in a Y-axis direction, and the second table 18 is supported by a rail provided on the first table 16 so as to be movable in an X-axis direction. A workpiece installation surface is provided on an upper surface of the second table 18, and a thin workpiece 62 that is a workpiece is secured to the workpiece installation surface. The thin workpiece 62 may be a workpiece formed by cutting a block-shaped metal material with a milling cutter or the like so as to leave a thin plate rising on a base. The machining apparatus 1 according to the embodiment machines the thin plate of the thin workpiece 62 to form a rising wall on the base.

A Y-axis motor 22 rotates a ball screw mechanism to move the first table 16 in the Y-axis direction, and an X-axis motor 20 rotates a ball screw mechanism to move the second table 18 in the X-axis direction. A Y-axis sensor 32 detects a position of the first table 16 in the Y-axis direction, and an X-axis sensor 30 detects a position of the second table 18 in the X-axis direction.

Provided above the second table 18 is a spindle 46 to which a cutting tool 50 is attached. According to the embodiment, an end mill tool including side cutting edges and end cutting edges is attached to a chuck provided on the spindle 46. A spindle motor 40 rotates the spindle 46, and a spindle sensor 42 detects a rotation speed of the spindle motor 40. The spindle 46 and the spindle motor 40 are secured to a spindle support 44.

The spindle support 44 has a back surface supported by a rail provided on the column 14 so as to be movable in a Z-axis direction. A Z-axis motor 24 rotates a ball screw mechanism to move the spindle 46 in the Z-axis direction. A Z-axis sensor 34 detects a position of the spindle 46 in the Z-axis direction.

The control device 100 drives and controls the X-axis motor 20, the Y-axis motor 22, the Z-axis motor 24, and the spindle motor 40 in accordance with the NC program. The control device 100 acquires respective detection values detected by the X-axis sensor 30, the Y-axis sensor 32, the Z-axis sensor 34, and the spindle sensor 42 and applies each of the detection values to drive control of a corresponding motor.

In the machine tool 10 shown in FIG. 3, the thin workpiece 62 is moved in the X-axis direction and the Y-axis direction by the X-axis motor 20 and the Y-axis motor 22, respectively, and the cutting tool 50 is moved in the Z-axis direction by the Z-axis motor 24, but such movements may be relative movements between the cutting tool 50 and the thin workpiece 62. That is, in the machine tool 10, the cutting tool 50 may be moved in the X-axis direction and the Y-axis direction, and the thin workpiece 62 may be moved in the Z-axis direction. As described above, it is not important which of the cutting tool 50 and the thin workpiece 62 is moved as long as the relative movement in each direction is enabled, so that mechanisms for enabling the relative movement between the cutting tool 50 and the thin workpiece 62 may be hereinafter collectively referred to as a “feed mechanism”.

Hereinafter, a machining method for forming a thin wall portion (hereinafter, referred to as “rising wall”) such as a rib will be proposed. First, before describing the machining method according to the embodiment, a comparative technique to be compared with the machining method according to the embodiment will be described.

### Comparative Technique

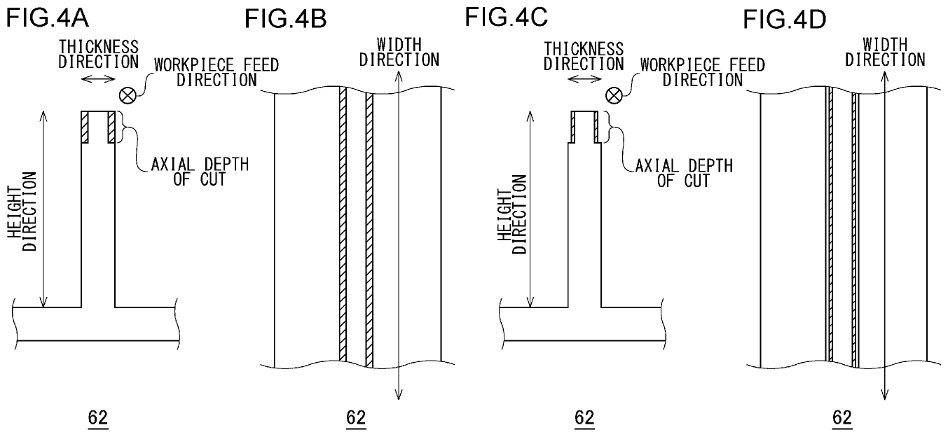

FIGS. 4A to 4D are diagrams for describing an outline of a machining method as a comparative technique.

Under the machining method as the comparative technique, a “roughing process” and a “finishing process” are alternately and repeatedly performed on the thin workpiece 62 to form the rising wall. The thin workpiece 62 is a workpiece having a thin plate rising on a base. In the comparative technique, in both the roughing process and the finishing process, the end mill is fed in a width direction (longitudinal direction) of the rising thin plate with the end mill being rotated to cut a side surface of the thin plate mainly with the side cutting edges of the end mill.

### Roughing Process

FIG. 4A is a diagram showing the thin workpiece subjected to the roughing process as viewed in the width direction of the thin workpiece, and FIG. 4B is a diagram showing the thin workpiece subjected to the roughing process as viewed from above. In a machining path of the roughing process in the comparative technique, the end mill is fed in the width direction of the thin plate with the side cutting edges of the end mill cut into the side surface of the thin plate. A hatched portion in FIGS. 4A and 4B indicates a region that is cut in the roughing process. The roughing process is performed on at least either of the left and right side surfaces of the thin plate of the thin workpiece 62 from an upper side of the thin plate.

### Finishing Process

FIG. 4C is a diagram showing the thin workpiece subjected to the finishing process as viewed in the width direction of the thin workpiece, and FIG. 4D is a diagram showing the thin workpiece subjected to the finishing process as viewed from above. In a machining path of the finishing process in the comparative technique, the end mill is fed in the width direction of the thin plate with the side cutting edges of the end mill cut into the side surface of the thin plate, in a similar manner to the machining path of the roughing process. A hatched portion in FIGS. 4C and 4D indicates a region that is cut in the finishing process. The finishing process is performed on a machined surface of the thin plate cut in the roughing process. When the finishing process is performed, one layer of the rising wall is finished.

The thin plate of the thin workpiece 62 is low in dynamic rigidity in a plate thickness direction, and is thus susceptible to regenerative chatter vibrations in the plate thickness direction. Therefore, for both the roughing process and the finishing process, it is necessary to limit an axial depth of cut to a predetermined depth mainly for the purpose of reducing a regeneration effect due to regenerative chatter vibrations. In the comparative technique, therefore, the roughing process and the finishing process with the limit imposed on the axial depth of cut are repeatedly performed on the thin plate of the thin workpiece 62, so as to finish the rising wall one layer by one layer from the upper side of the thin plate.

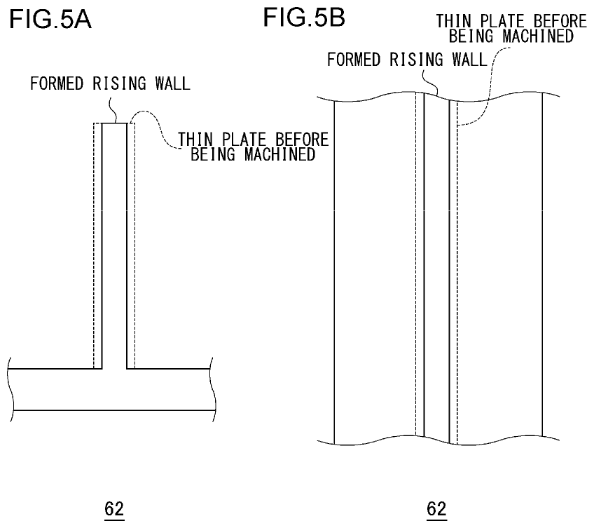

FIG. 5A is a diagram showing the formed rising wall as viewed in the width direction of the rising wall, and FIG. 5B is a diagram showing the formed rising wall as viewed from above.

Hereinafter, problems with the comparative technique will be examined.

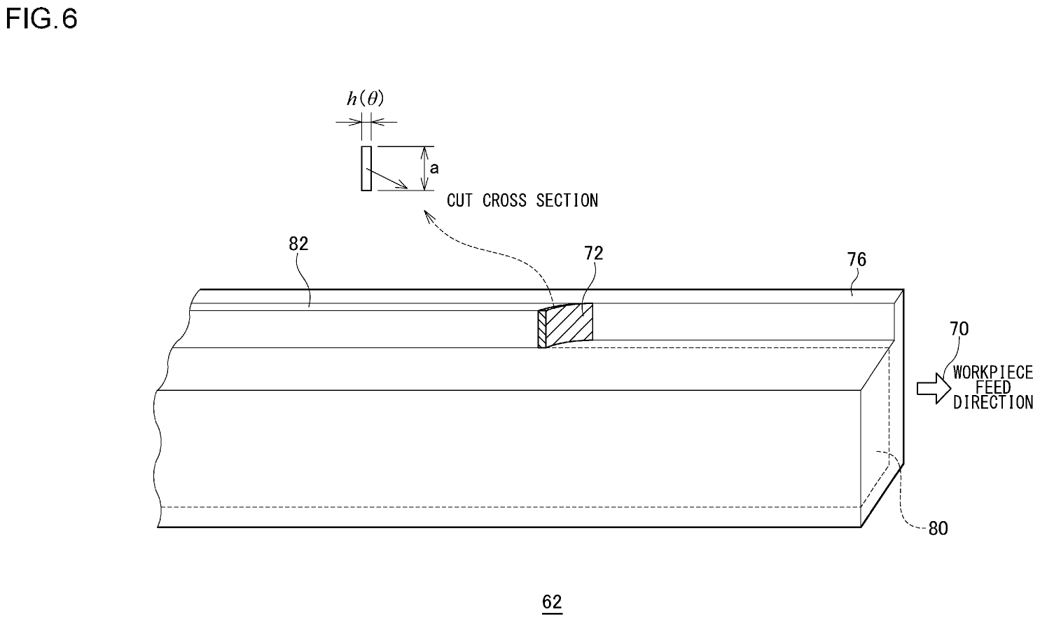

FIG. 6 schematically shows a state of the thin workpiece that is cut in the finishing process according to the comparative technique. As shown in FIGS. 4A to 4D, the process according to the comparative technique is performed on the left and right side surfaces of the thin plate in the width direction (longitudinal direction), but FIG. 6 shows, for the sake of simplification of description, a state where a side surface on a front side is subjected to the finishing process, and no illustration is given of a side surface on a back side of the thin plate.

During the finishing process, the thin workpiece 62 is fed in a feed direction 70, which is the width direction of the thin plate, relative to the end mill. A finishing process target region 82 indicates a region that is cut by the end mill in the machining path of the current finishing process, and a roughing process target region 80 having an approximately rectangular cross section indicated by a dotted line indicates a region that is cut by the end mill in the roughing process after the end of the current finishing process. A region 72 indicated by oblique hatching indicates a region that is cut off by one side cutting edge of the end mill in one rotation. A product portion 76 indicates a region where the finishing process is complete.

A frictional force (frictional force acting between a tool rake face and chips) acting on a momentary cut cross-sectional area (=axial depth of cut a (also referred to as cutting width)*momentary cutting thickness h(θ)) in the region 72 will be examined. As is known from the Stabler's law, the frictional force acts in a direction inclined from a direction orthogonal to a cutting edge by the same degree as a helix angle of the cutting edge (in other words, chips flow out in this direction). The feed direction 70 in the comparative technique makes the direction in which the frictional force acts close to the plate thickness direction of the thin plate. This means that a force component ratio kᵣ is large.

In this comparative technique, taking the machining path and the vibration direction into consideration, most vibration marks caused by vibrations of the thin plate when cut with a certain cutting edge are cut off with the next cutting edge. That is, an overlap ratio μᵣ is large. The overlap ratio μᵣ is one factor that determines chatter vibration stability, and the larger the overlap ratio μᵣ, the lower the chatter vibration stability.

Further, under the machining method according to the comparative technique, the rising wall is finished one layer by one layer from the upper side. Therefore, at the time when a certain layer is cut, there is a residual portion below the layer, but there is almost no residual portion at a height position where a vibratory force is applied, so that it cannot be said that the rigidity is sufficiently high. This means that a compliance G_{yy} is large.

A result of the above examination shows that the comparative technique has a problem that regenerative chatter vibrations are likely to occur as shown in Expressions 1 and 2 as the force component ratio kᵣ, the overlap ratio μᵣ, and the compliance G_{yy} each increases. In order to suppress the regenerative chatter vibrations, it is necessary to set the axial depth of cut of one layer less than or equal to a stability limit, so that high machining efficiency cannot be expected. Further, when the force component ratio kᵣ and the compliance G_{yy} are large, there is another problem that forced vibrations or static bending is likely to occur, and it is difficult to achieve high machining accuracy for the plate thickness.

### Machining Method According to Embodiment

Hereinafter, a machining method according to the embodiment will be described.

Under the machining method according to the embodiment, as in the comparative technique, the “roughing process” and the “finishing process” are alternately and repeatedly performed on the thin workpiece 62 to form a rising wall. According to the embodiment, in the roughing process, the end mill is fed in the height direction of the rising thin plate with the end mill being rotated, and a side of the thin plate is subjected to a plunge process from the upper side of the thin plate mainly with the end cutting edges of the end mill. Note that, when the plunge process is performed, theoretical roughness (hereinafter, simply referred to as “cusp”) having a cusp shape is left between two machining paths adjacent to each other. Therefore, in the finishing process, a process of removing at least the cusp between two machining paths of the plunge process is performed. Specifically, in the finishing process, the end mill is fed in the width direction (longitudinal direction) of the thin plate with the end mill being rotated, and the side surface of the thin plate is cut with mainly the side cutting edges of the end mill.

### Roughing Process

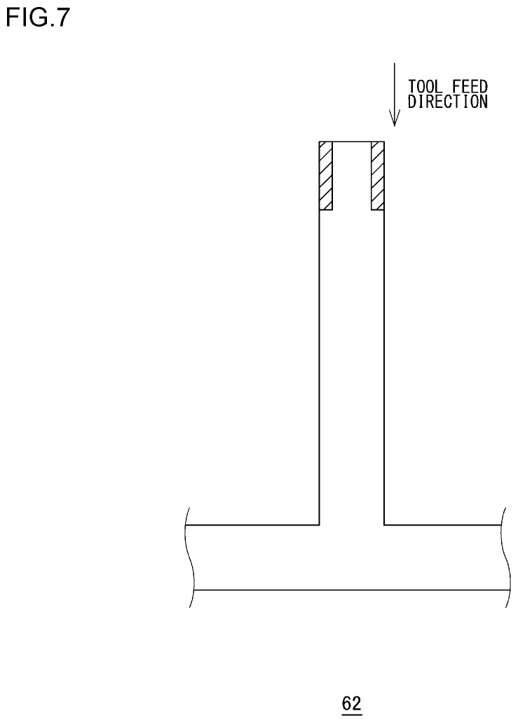

FIG. 7 is a diagram showing the thin workpiece subjected to the roughing process as viewed in the width direction. In the machining path of the roughing process according to the embodiment, the end mill is fed in the height direction of the thin plate with the rotation axis of the end mill approximately parallel to the height direction of the thin plate. Performing the plunge process as the roughing process shifts a direction of a dynamic cutting force by approximately 90 degrees relative to the plate thickness direction of the thin plate that is low in rigidity to suppress vibrations applied to the thin plate. A hatched portion in FIG. 7 indicate a region that is cut in the roughing process. The roughing process according to the embodiment is performed on both left and right side surfaces of the thin plate of the thin workpiece 62 from the upper side of the thin plate, but may be performed on only one of the side surfaces.

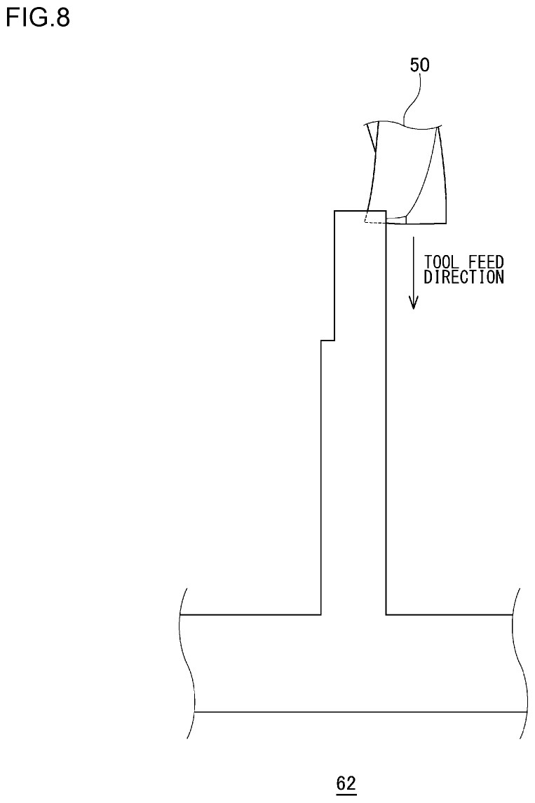

FIG. 8 shows how the plunge process is performed with the cutting tool 50. In the machine tool 10, the Z-axis motor 24 moves the spindle support 44 downward with the spindle 46 and the cutting tool 50 being rotated by the spindle motor 40. Accordingly, the cutting tool 50 first comes into contact with the upper side of the thin plate of the thin workpiece 62 with the rotation axis of the cutting tool 50 approximately parallel to the height direction of the thin plate, and the plunge process is performed.

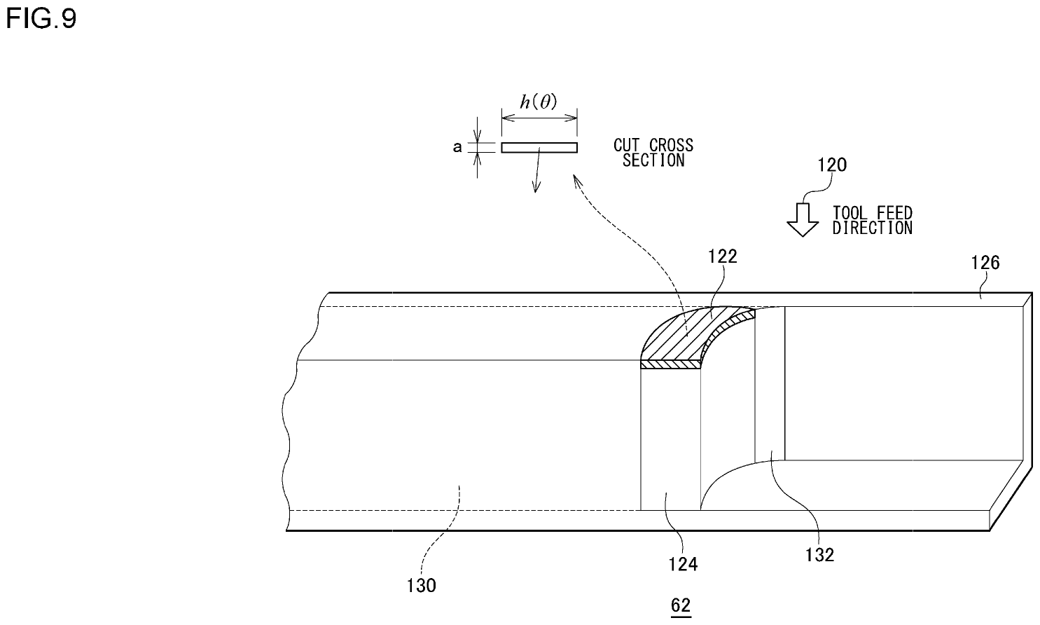

FIG. 9 schematically shows a state of the thin workpiece that is cut in the roughing process according to the embodiment. As shown in FIG. 7, the roughing process may be performed on both left and right side surfaces of the thin plate, but FIG. 9 shows, for the sake of simplification of description, a state where the side surface on the front side is subjected to the roughing process, and no illustration is given of the side surface of the thin plate on the back side.

In the roughing process according to the embodiment, the end mill, which is the cutting tool 50, is fed in a feed direction 120, which is the height direction of the thin plate, by the feed mechanism. The cutting tool 50 is a square end mill, and preferably has end cutting edges suitable for use in the plunge process. A region 124 indicates a region that is cut by the cutting tool 50 in the machining path of the current roughing process, and a region 122 indicated by oblique hatching indicates a region that is cut off by mainly one end cutting edge of the cutting tool 50 in one rotation. A roughing process target region 130 indicated by a dotted line indicates a region that is cut by the cutting tool 50 in the machining paths of the subsequent roughing process. A finishing process target region 132 is a cusp left between two machining paths of the roughing process. A product portion 126 indicates a region where the finishing process is complete.

When attention is paid to a momentary cut cross section of the region 122 and a momentary angle of the end cutting edge (approximately orthogonal to a circumferential velocity direction), in the machining path along the height direction of the thin plate, a frictional force acts approximately in the height direction (in other words, chips flow out approximately in the height direction orthogonal to the cutting edge). This allows the direction of the frictional force to be shifted by approximately 90 degrees relative to the plate thickness direction of the thin plate that is low in rigidity, and allows a reduction in the force component ratio kᵣ and a reduction in the force acting in the plate thickness direction (direction that is low in rigidity). Note that the direction of the cutting force greatly varies with the rotation during the plunge process, so that it can be thought that an average value from the start of cutting to the end of cutting affects chatter vibrations.

Next, since the square end mill is used in such a machining path, the cut cross section of the region 122 shows that a width h(θ) in the vibration direction is large, and a width a in a direction orthogonal to the vibration direction is small. Furthermore, vibration marks generated due to vibrations in the plate thickness direction at the time of cutting with one cutting edge are not necessarily cut off by the next cutting edge. For example, when a tool for use in the plunge process and a tool for use in the finishing process are separately prepared, clearance can be provided on the side cutting edges of the tool for use in the plunge process (the diameter is reduced toward the base). Alternatively, in order to prevent the side cutting edges from coming into contact with the wall surface that has already been processed during the plunge process, a slight tilt angle can be provided. With such configurations, it is ideally possible to make the overlap ratio μᵣ equal to zero.

The embodiment is intended to use a square end mill having a cutting edge with a sharp corner, but a practical square end mill is somewhat rounded in accordance with cutting specifications, for example, a radius end mill is intentionally provided with a round nose. Therefore, the width a increases more or less, and the overlap ratio μᵣ also takes a value greater than zero, but even in this case, the overlap ratio μᵣ can be brought close to zero.

Further, in the roughing process according to the embodiment, there is a possibility that vibrations before one machining path rather than before one cutting edge are regenerated, and regenerative chatter vibrations occur accordingly, but the overlap ratio can be reduced by making a pick feed of the machining path larger (the larger the pick feed, the smaller the overlap ratio). Further, for example, as disclosed in E. Shamoto, “Mechanism and Suppression of Chatter Vibrations in Cutting”, Denki-Seiko, Electric Furnace Steel, Vol. 82, No. 2, pp. 143-155, 2011, it is possible to suppress regenerative chatter vibrations by changing a cutting speed (rotation speed) for each path, so that it does not become an essential problem.

Further, in the roughing process according to the embodiment, when cutting is performed, a large amount of residual portion is present immediately adjacent to the current machining path, and the residual portion is present all over in the height direction. That is, the roughing process target region 130 acts as a portion having high rigidity against a vibration mode in a direction in which the thin plate bends, so that the compliance G_{yy} decreases.

As a result, the roughing process according to the embodiment allows a process to be performed with regenerative chatter vibrations suppressed.

### Finishing Process

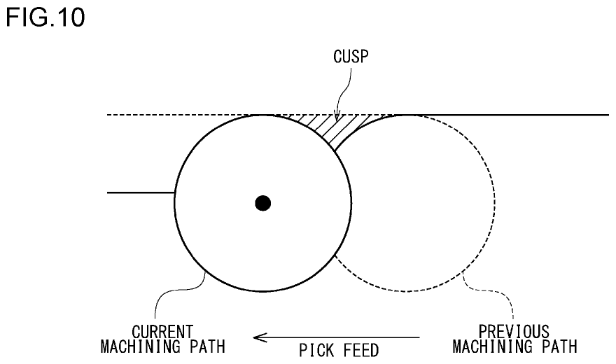

FIG. 10 is a diagram showing a cusp generated between two machining paths of the roughing process. A size of the cusp is determined in a manner that depends on an amount of the pick feed of the machining path of the roughing process. In the finishing process according to the embodiment, the cusp generated between two paths of the plunge process is removed each time by a side face process. That is, in the finishing process according to the embodiment, at least the wall surface subjected to the plunge process in the roughing process performed immediately before the finishing process is finished.

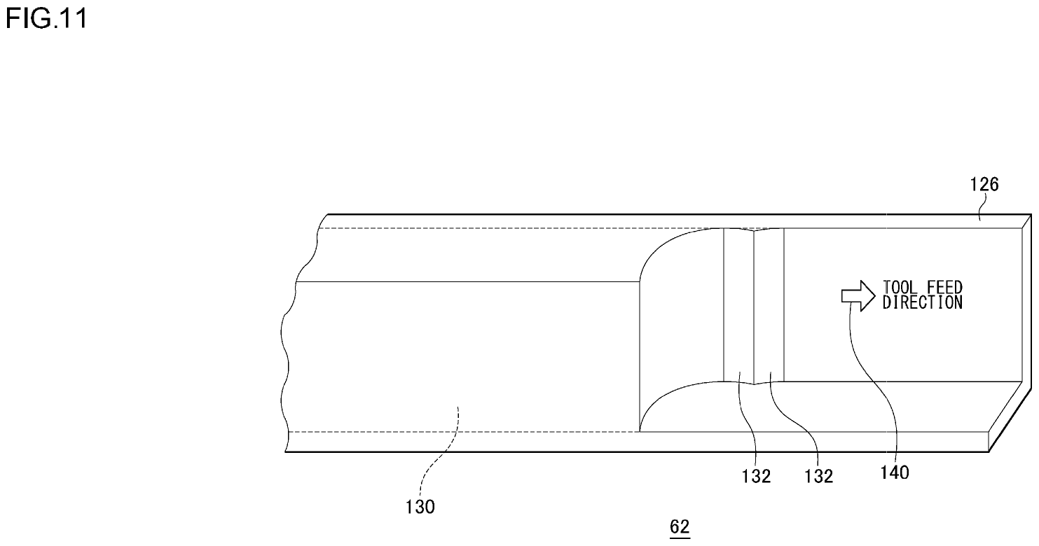

FIG. 11 is a diagram schematically showing a state of the thin workpiece that is cut in the finishing process of the embodiment. The finishing process is performed on at least either of the left and right side surfaces of the thin plate, but FIG. 11 shows, for the sake of simplification of description, a state where the side surface on the front side is subjected to the finishing process, and no illustration is given of the side surface of the thin plate on the back side.

In the finishing process according to the embodiment, the end mill is fed in a feed direction 140, which is the width direction (longitudinal direction) of the thin plate, by the feed mechanism. The finishing process target region 132 is a cusp left between two machining paths of the roughing process, and the side cutting edges of the end mill remove the finishing process target region 132 to form a finished surface. In the finishing process according to the embodiment, the roughing process target region 130 to be subjected to the roughing process next is left immediately adjacent to the finishing process target region 132, and acts as a portion having high rigidity against the vibration mode in the direction in which the thin plate bends, so that the compliance G_{yy} can be reduced. This allows the finishing process to be stably performed.

According to the embodiment, it is possible to stably form a thin rising wall having a ratio of the height to the wall thickness (height/wall thickness) greater than or equal to 5 by alternately and repeatedly performing the roughing process and the finishing process. Note that the ratio of the height to the wall thickness may be greater than or equal to 10.

In the roughing process, the thin plate may be cut in one machining path of the plunge process over the entire height of the thin plate (from the upper surface to the bottom), and when chatter vibrations become a problem during the finishing process, a limit may be imposed on the cutting amount of one machining path of the roughing process. In this case, it is possible to gradually finish the side surface of the rising wall by alternately and repeatedly (a plurality of times) the roughing process and the finishing process on the thin plate from the upper surface toward the bottom. Alternatively, only the finishing process may be performed a plurality of times for one roughing process. When the roughing process is performed in down milling, the finishing process may be performed in up milling or down milling, and when the roughing process is performed in up milling, the finishing process may be performed in down milling or up milling.

It is assumed that the finishing process shown in FIG. 11 is performed in a linear machining path in which the cutting tool 50 is moved in the feed direction 140 after the feed of the cutting tool 50 in the Z-axis direction is stopped in the roughing process. For the finishing process, a different machining path may be employed.

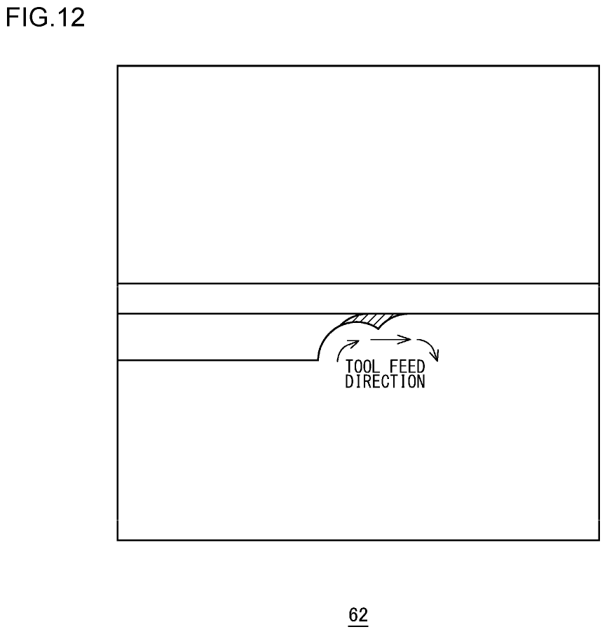

FIG. 12 is a diagram showing an example of a machining path that is a combination of curves. In the example shown in FIG. 12, the finishing process is performed in a machining path that is a combination of an arc path, a linear path, and an arc path. The use of such a machining path makes it is possible to achieve a finishing process with the cutting tool 50 always cut into the thin plate in the thickness direction, and it is therefore possible to improve the accuracy of the finished surface without leaving the roughed surface on the finished surface. Note that the combination of path loci may vary as long as the combination includes a locus used for forming the finished surface (locus along the finished surface).

Here, the amount of the pick feed and the depth of cut in the radial direction for the roughing process will be examined. An increase in the pick feed increases the machining efficiency of the roughing process, and also produces an effect of decreasing the force component ratio (the cut cross section becomes longer in the horizontal direction). On the other hand, from the viewpoint of the finishing process to be performed thereafter, a portion slightly away from the roughing process target region 130 also needs to be cut off, so that the compliance at the process point slightly increases, and chatter vibrations and the like (in addition, forced vibrations and static bending) are slightly more likely to occur. Further, at this time, since the cut-off amount in the finishing process increases, the time of one finishing process becomes slightly longer, but the overall machining efficiency including the roughing process is improved.

The larger the depth of cut in the radial direction, the smaller the force component ratio, and stability is brought about only on the basis of the fact, but the increase in the depth of cut in the radial direction makes |α_{0yy}| slightly larger.

In the roughing process according to the embodiment, the machining path of the plunge process may be set in order from the start end to the terminal end of the thin plate in the width direction (longitudinal direction) of the rising wall, but may be set in a different order. For example, of the plurality of times of the roughing process, in the first half of the plurality of times of the roughing process, both end sides of the rising wall in the width direction may be subjected to the plunge process, and in the second half of the plurality of times of the roughing process, a remaining center side of the rising wall in the width direction may be subjected to the plunge process. Since the compliance of the vibration mode on the ends of the thin plate in the width direction is large, it is possible to improve the stability of the entire process by first performing the plunge process on both the end.

The process of forming the thin rising wall having a rectangular cut cross section in a direction orthogonal to the width direction has been described above, but the thin rising wall to be processed may have a curved cross section.

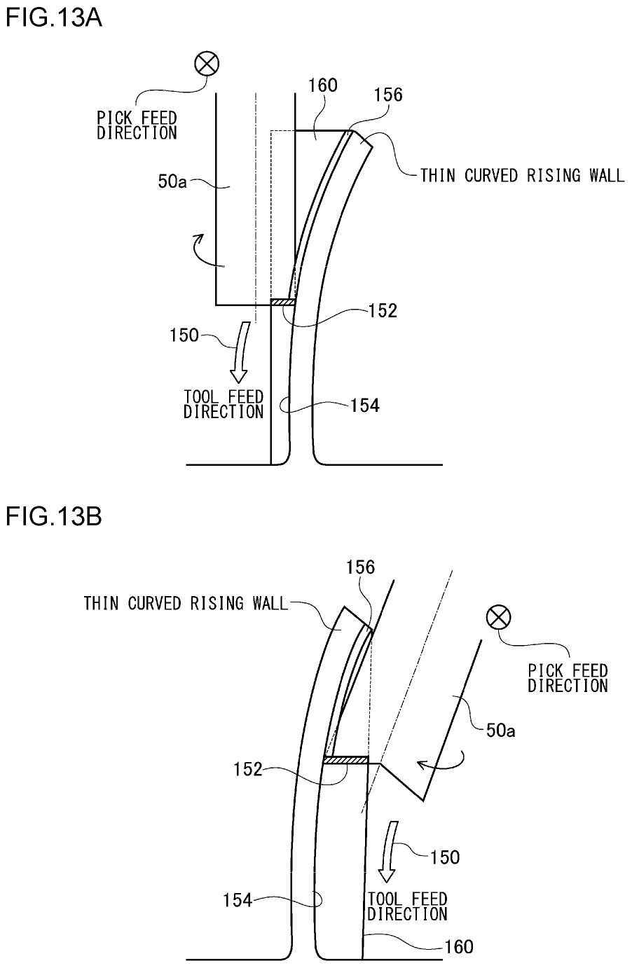

FIGS. 13A and 13B are diagrams for describing a roughing process on a thin rising wall having a curved cross section. FIG. 13A shows how a convex surface side of the curved rising wall is subjected to the roughing process, and FIG. 13B shows how a concave surface side of the curved rising wall is subjected to the roughing process. For example, a turbine blade has a thin rising wall structure with a curved cross section.

A region 152 indicated by oblique hatching indicates a region that is cut off in the plunge process by one end cutting edge of a cutting tool 50a in one rotation. A roughing process target region 160 indicates a region that is subjected to the plunge process with the cutting tool 50a in the machining paths of the subsequent roughing process. A finishing process target region 156 is a cusp left between two machining paths of the roughing process. A product portion 154 indicates a wall surface on which the finishing process is complete.

In the roughing process on the curved rising wall structure, the end mill, which is the cutting tool 50a, is fed by the feed mechanism in the feed direction 150 corresponding to a locus extending along the curve of the cross section. The cutting tool 50a used in the plunge process is preferably a square end mill having a sharp corner suitable for use in the plunge process.

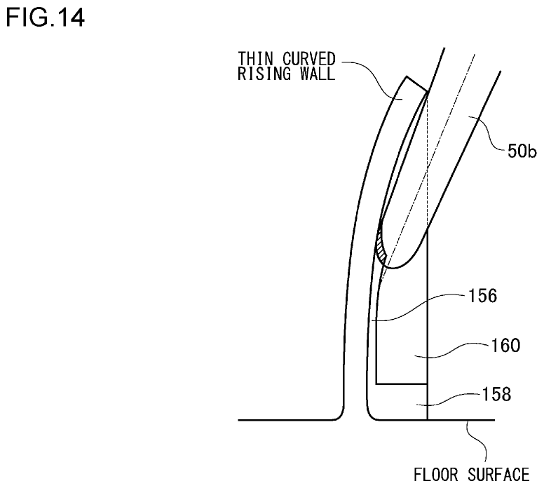

FIG. 14 is a diagram for describing the finishing process on the thin rising wall having a curved cross section. In the finishing process, the finishing process target region 156 that is a cusp and a residual portion 158 left on a floor surface are removed. A cutting tool 50b that is used in the finishing process on the curved rising wall structure may be a tapered ball end mill, a normal ball end mill, a radius end mill, an end mill called a barrel tool, or the like that is often used for finishing a curved surface. In the finishing process on the curved rising wall structure, it is difficult to finish the thin rising wall over the entire height (from the upper surface to the bottom) in one machining path, and thus the finishing process may be performed in a plurality of machining paths. That is, it is possible to form the rising wall having a curved cross section with high stability and high efficiency by repeating a set of one plunge machining path and a plurality of finishing machining paths. Note that when the finishing process (process of removing the cusp and the residual portion) is performed a plurality of times, the feed motion of the thin plate in the width direction and the pick feed in the height direction may be repeated, or the feed motion in the height direction and the pick feed in the width direction may be repeated.

According to the embodiment, the control device 100 controls the feed mechanism and the spindle motor 40 in accordance with a predetermined rising wall forming program to cause the machine tool 10 to perform the roughing process and the finishing process. The control device 100 and the machine tool 10 may each include a computer including a circuit block, a memory, and other LSI. As described above, the machine tool 10 and the control device 100 may be inseparable from each other.

The outline of an aspect of the present disclosure is as follows. According to one aspect of the present disclosure, there is provided a machining method for forming a rising wall by machining a workpiece, the machining method including a first process of feeding a cutting tool relative to the workpiece in a height direction of the rising wall to perform a plunge process on the workpiece, and a second process of feeding the cutting tool relative to the workpiece in a width direction or the height direction of the rising wall to perform a finishing process on the workpiece, the first process and the second process being repeatedly performed to form the rising wall. The use of the plunge process as the first process makes it possible to suppress vibrations of the rising wall during the first process.

This machining method makes it possible to stably form the rising wall having a ratio of a height to a wall thickness greater than or equal to 5. In the second process, at least a wall surface subjected to the plunge process in the first process performed immediately before the second process may be finished. The second process may include a process of removing a cusp left between two machining paths of the first process. Of a plurality of times of the first process, in the first half of the plurality of times of the first process, both end sides of the rising wall in the width direction may be subjected to the plunge process, and in the second half of the plurality of times of the first process, a center side of the rising wall in the width direction may be subjected to the plunge process.

According to another aspect of the present disclosure, there is provided a machining apparatus that forms a rising wall by machining a workpiece, the machining apparatus including a motor structured to rotate a spindle to which a cutting tool is attached, and a feed mechanism structured to move the cutting tool relative to the workpiece. The machining apparatus repeatedly performs a first process of causing the feed mechanism to feed the cutting tool relative to the workpiece in a height direction of the rising wall to perform a plunge process on the workpiece, and a second process of causing the feed mechanism to feed the cutting tool relative to the workpiece in a width direction or the height direction of the rising wall to perform a finishing process on the workpiece. The use of the plunge process as the first process makes it possible to suppress vibrations of the rising wall during the first process.

According to another aspect of the present disclosure, there is provided a program that causes a computer to repeatedly execute a first function of feeding a cutting tool relative to a workpiece in a height direction of a rising wall with the cutting tool being rotated to perform a plunge process on the workpiece, and a second process of feeding the cutting tool relative to the workpiece in a width direction or the height direction of the rising wall with the cutting tool being rotated to perform a finishing process on the workpiece.

What is claimed is:

1. A machining method for forming a rising wall by machining a workpiece, the machining method comprising:
a first process of feeding a cutting tool relative to the workpiece in a height direction of the rising wall to perform a plunge process on the workpiece; and
a second process of feeding the cutting tool relative to the workpiece in a width direction of the rising wall to perform a finishing process on the workpiece, wherein
each time a cusp is generated after the first process, the second process is performed to remove the cusp, and the first process and the second process are repeatedly performed to form the rising wall having a ratio of a height to a wall thickness greater than or equal to 10.

2. The machining method according to claim 1, wherein
the second process includes a process of removing the cusp left between two machining paths of the first process.

3. The machining method according to claim 1, wherein
in a first half of a plurality of times of the first process, both end sides of the rising wall in the width direction are subjected to the plunge process, and in a second half of the plurality of times of the first process, a center side of the rising wall in the width direction is subjected to the plunge process.

4. The machining method according to claim 1, wherein
the rising wall to be formed is a rising wall having a curved cross section, and the second process is performed in a plurality of machining paths.

5. The machining method according to claim 1, wherein
adjacent to a machining path of the first process, a region is present, the region has a thickness of at least one third the wall thickness of the rising wall and is cut in subsequent machining paths of the first process.
